(19) United States
(12) Patent Application Publication
(10) Pub. No.: US 2017/0276827 A1
(43) Pub. Date: Sep. 28, 2017

(54) SUPERCONDUCTING GRAVITATIONAL WAVE SENSOR

(71) Applicants: Armen Gulian, Ashton, MD (US); Joe Gaines Foreman, Alexandria, VA (US); Louis Sica, JR., Alexandria, VA (US); Vahan R. Nikoghosyan, Ashtarak (AM); Shmuel Nussinov, Kensington, MD (US)

(72) Inventors: Armen Gulian, Ashton, MD (US); Joe Gaines Foreman, Alexandria, VA (US); Louis Sica, JR., Alexandria, VA (US); Vahan R. Nikoghosyan, Ashtarak (AM); Shmuel Nussinov, Kensington, MD (US)

(21) Appl. No.: 15/082,958

(22) Filed: Mar. 28, 2016

(51) Int. Cl. G01V 7/10; G01L 3/22

(52) U.S. Cl. CPC G01V 7/10; G01L 3/22

(57) ABSTRACT

A superconducting gravitational wave senser includes a toroid-like torque body having first and second diametrically opposed mass objects to provide a bi-pole mass distribution about its Z-axis for torque perturbations by gravitational waves. The torque body includes superconducting material that produces a magnetic field when perturbed; the field indicative a gravitation wave.

### CROSS-REFERENCE TO RELATED APPLICATION

This application claims the benefit of U.S. Provisional Patent Application 62/177,912 filed Mar. 27, 2015 by the applicants herein and entitled “Superconducting Antenna For Gravitational Wave Detection”, the disclosure of which is incorporated herein by reference.

### BACKGROUND

Gravitational waves, first postulated by Einstein, have been detected by the Laser Interferometer Gravitational-Wave Observatory (LIGO). The LIGO detector detects the difference in the path length of the two arms of a interferometer detector using the principles of interferometry.

Optical interferometric devices, such as LIGO, cannot provide the benefit of practically infinite coherence time, while, by contrast, the current in a superconducting ring, though in a metastable state, can theoretically flow indefinitely. Thermodynamic noise cannot degrade the phase coherence of a Bose-Einstein Condensate (BEC) or a Cooper-Pair Condensate (CPC). Current noise in a superconductor is consequent to the fluctuation of the Condensate wave function. This noise will be strongly reduced by the unique property of BECs to restore the nominal phase and amplitude values of their quantum wave function, thus making the coherence time infinitely long.

The density of photons in a laser beam is Poisson distributed and therefore fluctuates even for a beam of nominally constant power which determines the signal-to-noise ratio (SNR). By raising the power of the laser, the signal-to-noise ratio can be improved, although increased laser power introduces other noise sources. Considering noise, superconductors have single-particle excitations (unpaired electrons and Cooper Pairs) separated by an energy gap from the CPC. These excitations generate thermodynamic noise. Charge neutrality couples the motion of CPC and single-particle excitations. However, at sufficiently low temperatures, the number of single-particle excitations (either electrons or holes) is exponentially small because of the energy gap and the perturbing effects on the CPC become negligible. Low noise associated with superconducting devices is an invaluable asset when dealing with small signals induced by gravitational waves.

In contrast to the LIGO interferometer configuration, the present invention converts the gravitational waves into rotational motion using a low-noise superconducting torque body based on Cooper-Pair Condensates in superconductor materials; CPCs are related to Bose-Einstein Condensates (BECs) that are considered low-noise entities.

### SUMMARY

A superconducting sensor system suitable for gravitational wave detection includes a gravitational wave sensing structure having a bi-pole mass distribution about it Z-axis. The gravitational sensing structure is ‘floated’ in a cryogenic liquid, usually liquid helium, so that the gravitational sensing structure is free to rotate about its Z-axis in response to successive gravitational waves. Because of the nature of the bi-pole mass distribution, the successive gravitational waves torque the sensing structure in one direction and then the other direction abut its Z-axis. The sensing structure includes an integrally formed superconducting loop or is attached to a superconducting loop cooled below its critical transition temperature T_{c} by the liquid helium so that Cooper-Pairs are formed with the lattice atoms being ionized to provide a positively charged lattice points. As the superconducting loop is torqued in a direction about its Z-axis, the rotary displacement of the positive lattice ions generates a magnetic field that is indicative of the gravitational wave.

This magnetic field generated by the rotation of the lattice ions is detected either by 1) a SQUID detector or SQUID detector complex which is positioned suitable to detect the magnetic field, or 2) using the magnetic field to generate a current in a pick up coil which is then detected by a SQUID detector or SQUID complex detector.

The superconducting magnetic field sense loop has a current induced therein by the magnetic filed and is connect to or associated with a SQUID detector or SQUID detector complex to provide an output signal representative of the detected gravitational waves.

The gravitational wave sensing structure is suitable for use as a gravitational wave detector and, differently configured, can serve as a gravimeter function, a gravity gradiometer function, rate-of-turn transducer function, and an accelerometer function.

### BRIEF DESCRIPTION OF THE DRAWING

FIG. 1 is an elevational view, in partial cross-section, of the organization of a gravitational wave sensing structure;

FIG. 2 is a detail of a torque body component shown in FIG. 1;

FIG. 3 is a side elevational view, in partial cross-section view of the torque body shown in FIGS. 1 and 2;

FIG. 4 is a detail of a torque body variant;

FIG. 5 is side elevation, in partial cross-section view of the torque body shown in FIG. 4;

FIG. 6 is a view of a “barbell” structure having a mass at each end superposed over a gravity wave representation such that a counterclockwise torque is applied thereto;

FIG. 7 is a view of the “barbell” structure of FIG. 6 superposed over a successive gravity wave representation such that a clockwise torque is applied thereto;

FIG. 8 represents an arrangement for calibrating the position of the torque body;

FIG. 9 illustrates a gravitational wave depiction superimposed over a torque body for a first portion of a gravitational wave;

FIG. 10 illustrates a gravitational wave depiction superimposed aver a torque body for a second portion of a gravitational wave;

FIG. 11 illustrates a variant of the gravitational wave sensing structure having a bearing structure associated with the torque body;

FIG. 12 illustrates a further variant of the gravitational wave sensing structure having a taut-band suspension associated with the torque body;

FIG. 13 illustrates four distributed mass objects subject to first portion of a gravitational wave;

FIG. 14 illustrates the four distributed mass object subject to a second portion of a gravitational wave;

FIGS. 15 and 16 illustrate, in exaggerated form, respective resilient loop deformations corresponding to FIGS. 13 and 14;

FIG. 17 represents a rectangular torque body having mass portions A and B at opposite diagonal corners; and

FIG. 18 represents the mass distribution of FIG. 17 in terms of distributed mass objects.

### DESCRIPTION

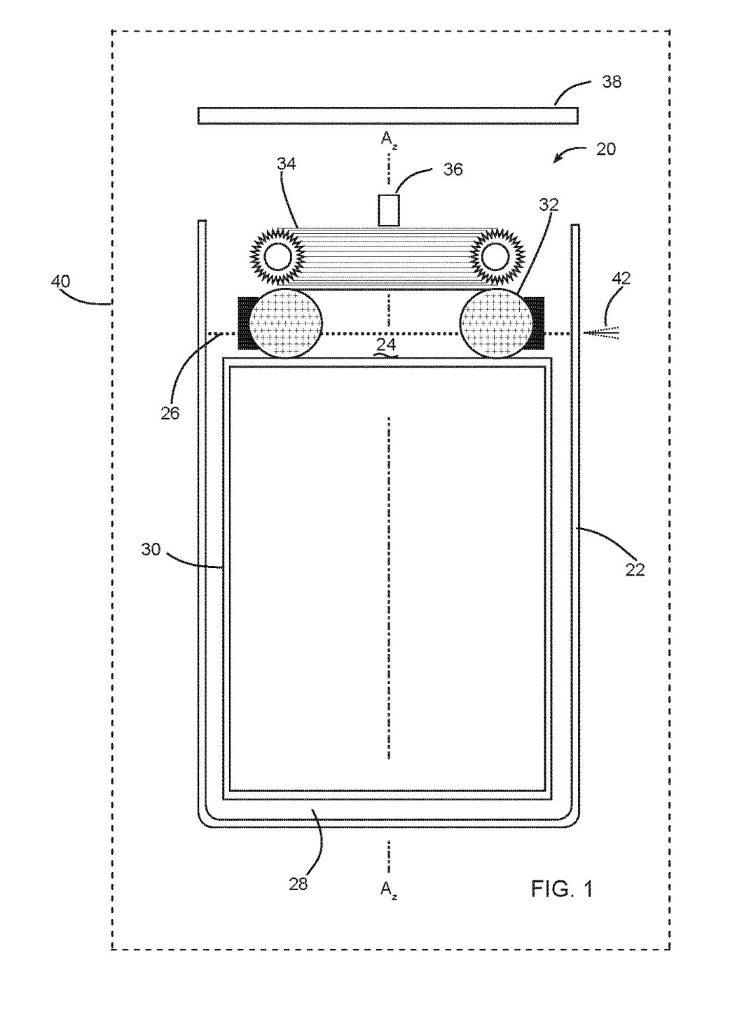

A currently preferred embodiment of a gravitational wave sensor is shown in cross-section in FIG. 1 and is designated therein by the reference character 20. As shown, the gravitational wave sensor 20 includes a container 22 having a quantity of liquid helium 24 therein with the surface of the liquid helium indicated at 26. Liquid helium is preferred as it does not support electron flow below its critical transition temperature T_{c} and can be considered an dielectric. Because liquid helium has a relatively low density (0.125 gm/cm³), a buoyancy control device 30 provides buoyant support for the various structures described below. The buoyancy control device 30 takes the form of an enclosed chamber or plenum having a volume sufficiently large to provide buoyant support for a torque body 32 having mass objects A1 and A2 thereon and a magnetic-field sense loop 34. The interior of the buoyance control device 20 can be evacuated 61 can be filled with an inert gas.

The annular or toroidally shaped torque body 32, described more fully below, floats at or near the surface 26 of the liquid helium 24. A superconducting magnetic-field sense loop 34 is mounted above the torque body 32 and is spaced apart by a gap so that the torque body 32 can rotate about its Z axis relative to the magnetic-field sense loop 34. The magnetic-field sense loop 34 is coupled to or integrated with a SQUID detector 36 (or a multi-SQUID array), for example, by being placed in a sensing relationship adjacent to the magnetic-field sense loop 34 or placed in series circuit therewith, to provide a signal output indicative of the sensed magnetic field and, consequently, indicative of the gravitational perturbation. Since SQUID detectors typically have a sensing loop with Josephson junctions, a modified SQUID detector can have a sensing loop with Josephson junctions as the magnetic-field sense loop 34.

A cover 38 is provided to close the container 22 to prevent the liquid helium from climbing the walls thereof and flowing out of container 22.

As represented by the reference character 40, the entire gravitational wave sensor 20 is enclosed within a shielding containment that shields the gravitational wave sensor 20 from external magnetic, electrostatic, and electrical fields. The containment 40 is preferably fabricated from mu-metal or a functionally similar material. Additionally, the gravitational wave sensor 20 is isolated from mechanical vibration, and insulated against changes in the environmental temperature.

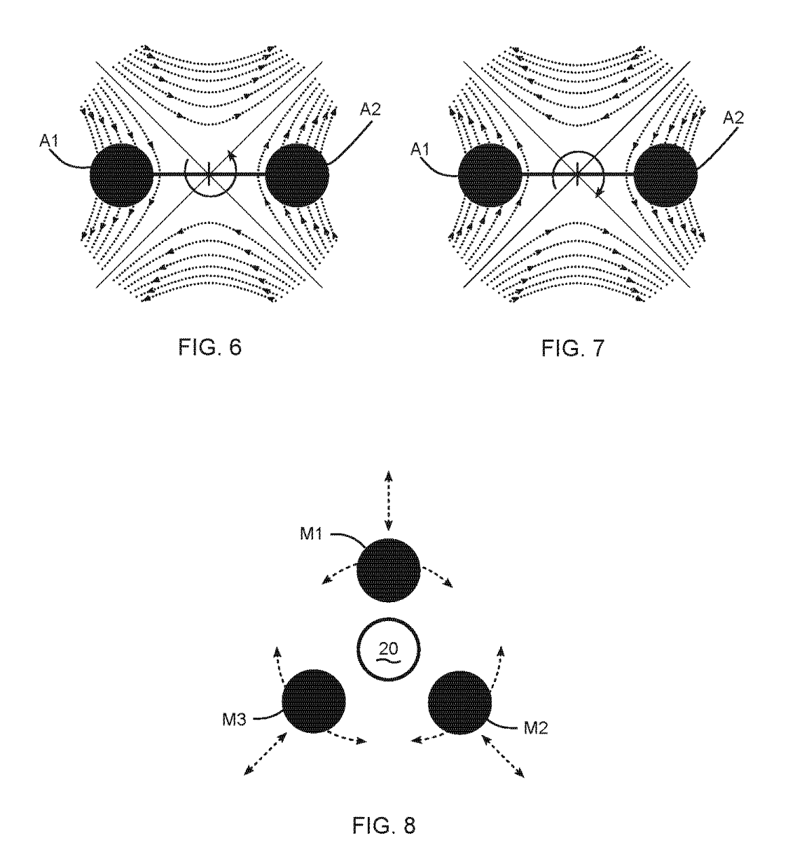

The organization shown in FIG. 1 is well-suited for sensing gravitational waves that are or at least resemble sinusoidal wave patterns so that the toque-body 32 experiences successive torques and a counter-torques about its Z axis Az-Az with successive alternations of the gravity wave, as explained below in relationship to FIGS. 6 and 7.

The organization of FIG. 1 uses a torque body 32 that is not inherently self-centering or self-aligning. As indicated at 42, it is preferred that the mass of the torque body 32 be distributed to prevent or minimize any portion thereof causing a “tipping” misalignment that could provide an uneven gap between the torque body 32 and the magnetic field sensing loop 34. Since the torque body 32 is buoyant, adding or removing liquid helium can control the gap spacing between the torque body 32 and the magnetic-field sense loop 34. The distance the torque body extends above the surface 26 of the liquid helium can be controlled by controlling the volume of the buoyance control device 30.

While the torque body 32 has been shown as floating in liquid helium so part of the torque body 32 is above the surface 26 thereof partial or total submersion of the torque body 32 is acceptable.

There may be circumstances in with the torque body 32 drifts from its preferred aligned position for a variety of reasons. In this case and as shown in FIG. 8, a plurality of near-field mass objects, M1, M2, M3, can be positioned about the gravitational wave sensor 20; the respective positions thereof are adjusted to bias the torque body 32 toward and to its preferred alignment.

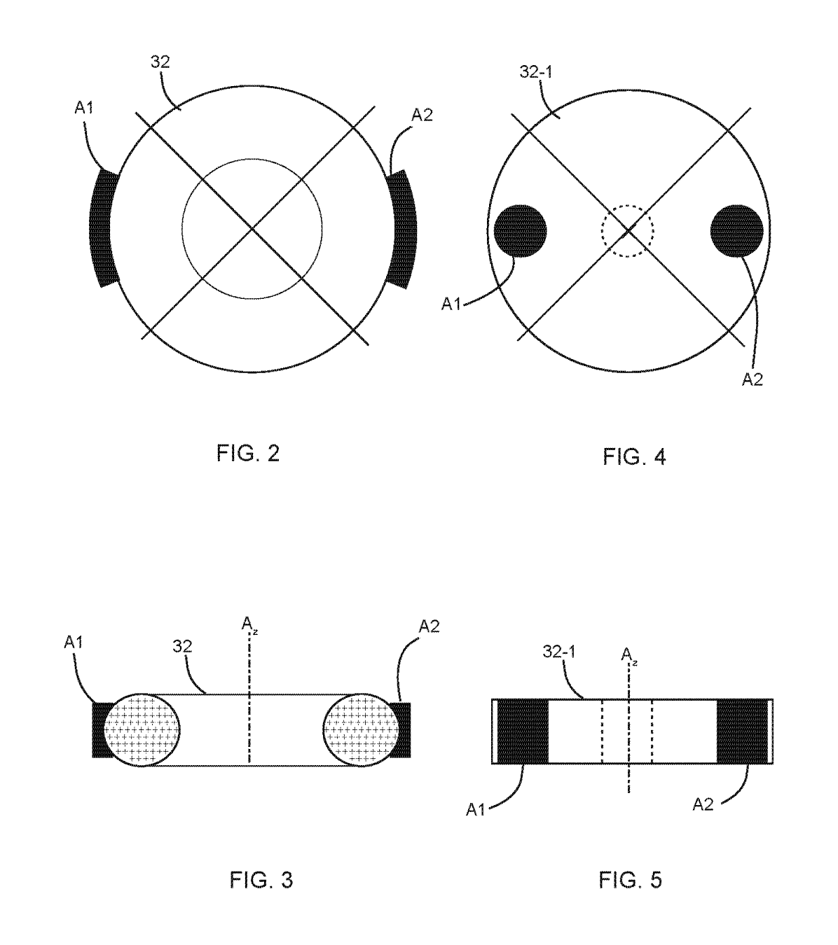

As shown in the top view of FIG. 2 and the side view of FIG. 3, the torque body 32 can be divided into four equi-angular segments (90°) with two opposite segments having, respectively, a mass object A1 and A2 attached or secured thereto to provide a bi-pole mass arrangement.

In FIGS. 6 and 7, the mass object A1 and the mass object A2 are represented as spheres at the opposite ends of a connecting bar (a “barbell” configuration). FIGS. 6 and 7 also show respective “+” type gravitational waves superimposed over the barbell structural organization. The gravitational wavefronts include curved-line representations with directional arrows in opposite directions in different quadrants. In FIG. 6, the superposed gravitational wave will tend to torque the connected mass objects A1 and A2 counterclockwise while in FIG. 7, the superposed gravitational wave will tend to torque the connected mass objects A1 and A2 clockwise.

The mass objects A1 and A2 are preferably fabricated from high-density materials, such as tungsten or gold (each 19.3 g/cm3), depleted uranium (19 gm/cm3), or lead (11.4 g/cm3). The particular material chosen for mass objects A1 and A2 has a higher specific density then the material between the A1 and A2 sectors so the torque body 32 approximates the mass-distribution of the “barbell” shown in FIGS. 6 and 7.

While a toroid shape is presently preferred, other shapes are not excluded including the discoidal shape 32-1 shown in FIGS. 4 and 5 in which the mass objects A1 and A2 are embedded near the peripheral edge of the discoid.

In the currently preferred embodiment, the torque body 32 serves as a carrier for the mass objects A1 and A2 and as a magnetic field generator responsive to rotations caused by the interaction with the alternating gravitational waves. To this end, the torque body 32 is fabricated from a superconductor, such as tin (Sn). When the superconductor is cooled below its critical transition temperature T_{c} the electrons form Cooper Pairs. As a consequence, the atoms at the lattice points are ionized and have a positive charge as schematically illustrated by the “+” signs in the cross-sectional view of FIG. 3. While the lattice ions are immobile relative one another in their respective lattice positions, displacement of the lattice will induce a magnetic field, as explained more fully below.

The torque body 32, as described above, serves as a carrier for the mass bodies A1 and A2 and as a magnetic field generator by virtue its fabrication using a superconductor. As can appreciated, two separate structures can also be used. For example, a torque body with its mass objects can be fabricated from a glass, polysilicon, fused quartz, ceramic, or similar electrically and magnetically inert material. A separate superconducting magnetic field generator can then be affixed to the torque body to generate a magnetic field in response to displacement of both connected structures caused by interaction with a gravitational wave.

In FIG. 1, the superconducting magnetic field sense loop 34 is supported above the torque body 32 and separated by a gap. The magnetic field sense loop 34 is preferably fabricated from a substrate, such as glass, polysilicon, fused quartz, ceramic, or similar electrically and magnetically inert material, with an exterior surface having a superconductor material layer, such as tin, deposited or otherwise formed thereon or applied thereto. While a superconductor can be used to fabricate the magnetic field sense loop 34 in its entirely, superconduction is a “skin” effect that conducts within the London penetration depth λ_{d}. Thus, the surface of any substrate used to fabricate the magnetic field sense loop 34 is provided with a superconductor layer thicker than the London penetration depth λ_{d}; suitable superconductors include tin (Sn) and lead (Pb). The superconductor layer can be applied, for example, by chemical vapor deposition, plasma vapor deposition, sputtering, atomic layer deposition, or by any suitable process used for applying or depositing thin layers.

Since superconduction is a “skin” effect, the responsiveness of the magnetic field sense loop 34 can be increased by increasing the surface area of the magnetic field sense loop 34. As shown in FIG. 1, the exterior surface of the magnetic field sense loop 34 includes radially outward extending triangular projections that serve to increase the surface area.

While the surface-area enhancement of FIG. 1 is preferred, the use of a smooth-surface magnetic field sense loop 34 is not precluded.

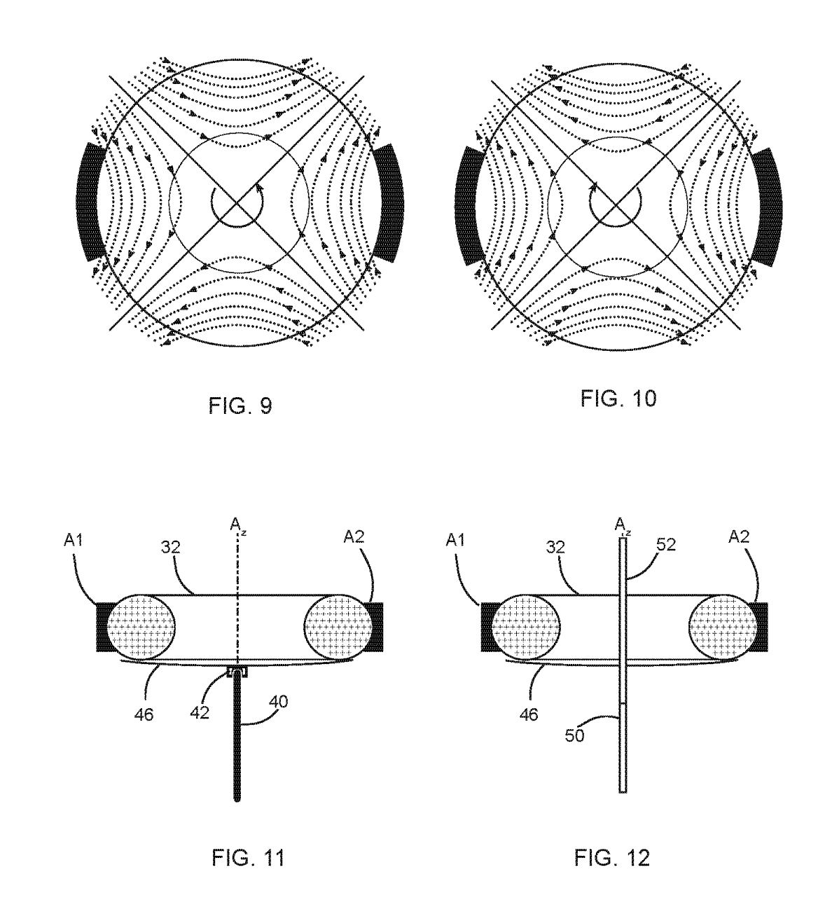

In operation, the gravitational wave sensor 20 of FIGS. 1, 2, and 3 is exposed to periodic gravitational waves, for example, from the Crab nebula. As the wave transits through the sensor 20 (as represented in FIGS. 9 and 10), the torque body 32 will experience a successive counterclockwise and clockwise torques to, in turn, cause small counterclockwise and clockwise rotations of the torque body 32 with the displacement of the positive ions of the lattice generating a magnetic field for sensing by the magnetic field sense loop 34.

The magnetic field provided by the torque body 32 can be directly measured by a single SQUID detector 36, a plurality of SQUID detectors, or, as shown in FIG. 1, induced into the enhanced surface-area superconducting magnetic-field sense loop 34 for sensing by a SQUID detector 38 or by a plurality of SQUID detectors. As mentioned above, SQUID detectors typically have a sensing loop with Josephson junctions, a modified SQUID detector can have a sensing loop with Josephson junctions as the magnetic-field sense loop 34.

In the description above, the torque body 32 has been described as an annular or toroidal structure. Other types of configurations are equally suitable, including, for example, the discoidal configuration of FIGS. 4 and 5 showing a torque body variant 32-1.

In general, two types of gravitational wave signals relevant to the device described herein are known: pulsed of shorter duration and perhaps greater magnitude wave (like those that LIGO reported detecting) and periodic (continuing for months or years, but of lower magnitude for likely known sources). In the following calculations, a periodic source is assumed and is likely to detect gravitational radiation of the magnitude expected from the Crab Pulsar.

A variant of the gravitational wave sensor 20 is shown in the detail view of FIG. 11. As shown, a support disc 46 is attached to the underside of the torque body 32 and includes a downwardly opening cup bearing 42 that sits atop a upstanding post 40. The tip of the post 40 is received within the cup bearing 42 with sufficient clearance to allow some lateral movement of the torque body (28 or 28-1); the buoyancy of the torque body is adjusted so that the post 40 does not support the weight of the torque body (28 or 28-1). The arrangement of FIG. 11 effectively locates the torque body in the preferred position.

A further variant of the gravitational wave sensor 20 is shown in cross-section in FIG. 12. In the organization of FIG. 12, the torque body 32 is supported by an axially aligned “taut-band” suspension using narrow-band metal ribbons 50 and 52 to maintain the axial alignment. If desired, each band can be subject to an axial counter-twisting that tends to hold the torque body 32 in place. While the descriptor “taut” implies a tensioned band, any tensioning sufficient to prevent small up/down movements of the torque body 32 is acceptable.

In general, two types of gravitational wave signals are relevant to the device described herein: pulsed gravitational waves of shorter duration and perhaps greater magnitude (like those that LIGO reported detecting) and periodic gravitational waves (continuing for months or years, but of lower magnitude for likely known sources). In the following calculations, a periodic source is assumed and, as indicated, gravitational waves radiation of the magnitude expected from the Crab Pulsar is detectable.

Assuming a gravitational wave of strain h=hₒ Sin (ωt) propagates perpendicular to the plane of the detector, where h₀ is the strain amplitude, it will adiabatically impart to and retrieve a kinetic energy from the quadrapolar mass distribution discussed below. The kinetic energy of the rotation is:

Eₖᵢₙ=mₜₒₜ(Lωhₒ)²/2

where mₜₒₜ is the total mass of the torque body. This kinetic energy, or at least a part thereof, is converted into a current in the pickup coil.

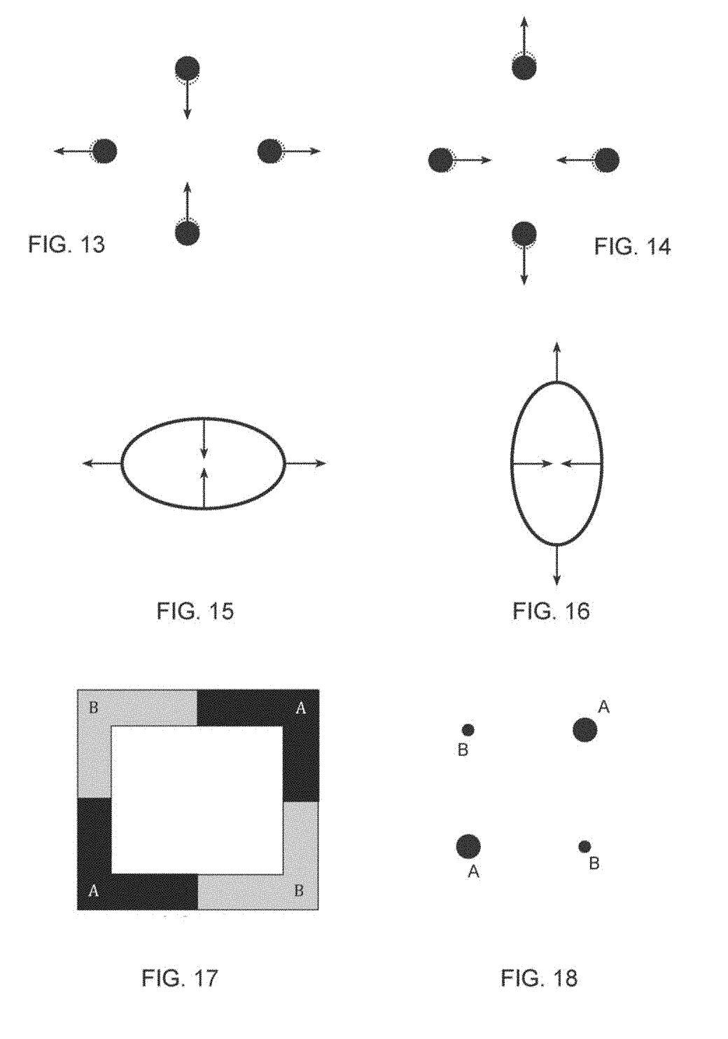

FIGS. 13 and 14 illustrate four equal mass objects distributed about a center point. During the first half-period of a gravitational wave, the x-components of the gravitational wave forces tend to pull the two horizontal mass objects apart and pull the two vertical mass objects together as indicated by the arrows and the dotted-line representations. The same pattern, but with all forces and resulting motions reversed, occurs in the end half-period as illustrated in FIG. 14.

FIGS. 15 and 16 correspond to FIGS. 13 and 14 and represent, respectively and in highly exaggerated form, a resilient loop undergoing the stretch-and-squeeze and successive squeeze-and-stretch forces. This succession of stretch-end-squeeze effect followed by a squeeze-and-stretch is characteristic of gravitational waves.

FIG. 17 presents a rectangular torque body having a mass object A in the lower left and upper right corners and a mass object B at it lower right and upper left corners. FIG. 17 shows four equivalent mass objects and indicates that mass objects A are substantially more massive than mass objects B.

Let p_{A} and p_{B} be the densities of the materials A and B respectively. If p_{A}=p_{B} then all forms would effectively cancel and there would be no torque. However, in the case p_{A}>p_{B} the torque body rotates around its center of mass.

Ions in the lattice of a superconducting material will move with the torque body, while the Cooper pairs will partially stay in rest. As a result, a magnetic flux will be generated by the rotating loop. A superconducting magnetic field sense loop suspended in a plane parallel to torque body and secured to stay at rest and mechanically detached from the moving system will experience an opposite current therein because the sum of the two fluxes is quantized and adds to zero (fluxoid quantization).

Calculations of the current: For simplicity, the mass of the moving superconductor loop is considered to be negligibly small compared to the mass of the torque body, and to simplify further, assume the case where p_{A}>>p_{B}. Then the linear velocity of rotation of the loop of radius L in response to The gravitational wave

$$v ∼ \frac{d L}{dt} ∼ L \frac{dh}{dt} ∼ L ω {h}_{0}$$

relative to a laboratory reference system. In this laboratory reference system, the Cooper pairs stay partially (because of the magnetic field of the rotating ions) at rest relative to the lattive ions of the solid torque body, and the ions of the superconductor material move and constitute a current. Correspondingly, for an observer moving with the ions, the Cooper pairs move through the loop and constitute a current. Assume that the diameter d of the superconducting wire is less than the London penetration depth λ_{L} of the superconductor: λ_{L}. This ensures that the superconducting current density j is approximately constant within the wire cross section (so that the Meissner effect does not preclude the motion of charges in the bulk of the wire). Thus, the current I=I Cos ωt will have amplitude:

I₀˜jd²˜enLh₀d²

Substituting from the values from Table 1 the current amplitude equals I₀˜10⁻⁷ electrons per second which is approximately 10⁻²⁶ Amperes.

TABLE 1

| | | |
|---|---|---|
| n ~10³⁰ meter³ | d ~10⁻⁷ meter | L ~10 meter |
| ω ~10² second⁻¹ | h₀ ~10⁻²⁶ | |

A current I in a loop with the radius R creates a magnetic field B, which at a distance α from the loop axis in the plane of the loop is equal to

$$\begin{matrix}B ( α ) = \frac{{μ}_{0} I}{2 π ( R + α )} \{ K ( {k}_{0} ) + \frac{R + α}{R - α} E ( {k}_{0} ) \} & \\ and & \\ {k}_{0} = 2 \frac{\sqrt{R α}}{R + α} & \end{matrix}$$

where K(k) and E(k) ere complete elliptic functions of the first and second kind. Integrating this, the total flux in the loop:

$$Φ = 2 π {\int }_{0}^{R} B ( α ) α d α ∼ {10}^{- 4} Weber ,$$

for R=L=10 meter, and I=1 Ampere. In the case of current amplitude 10˜10⁻²⁶ Ampere, the flux will be φ˜10⁻⁺Weber or, in terms of the magnetic flux quantum,

$${ϕ}_{0} = \frac{h}{2 e} ∼ 207 \cdot {10}^{- 15} Weber$$

where h is Planks constant, and a is the charge of the electron, resulting in

φ=10⁻¹⁵ φ₀Weber

this flux is cancelled by a flux of equal value due to oppositely directed current induced in the second, non-moving, loop. The latter current could be measured by coupling it via flux transformer to a SQUID pick-up loop using standard methods of superconducting electronics. A principal requirement follows from the sensitivity of contemporary SQUIDs, that routinely achieve a noise floor δφ˜10⁻⁶φ₀Hz^{1/2} at 4.2K.

Better results can be expected at much lower temperatures. However, it is clear that the current should be much larger than I₀˜10⁻²⁶ Ampere to observe sources producing h₀˜10⁻²⁶ (such as the Crab Nebula).

Another way off enhancing the current is to use a wire with a greater diameter than the London depth d>>λ_{L} and further enhanced with a corrugated surface as shown in FIGS. 1 and 3. In this case, the current will flow in the surface layer within the London thickness in a direct analogy with the physics of London's momentum), but the effective cross section will be larger. Then the flux will be greater by

$$\frac{η d}{{λ}_{L}}$$

where η>>1 is a factor due to the corrugation. If η˜10² and d˜1 cm the fly generated in the primary loop is φ˜10⁻⁸φ₀ and the signal will be above the noise floor of the SQUID for an observation time t=104 seconds (less than a day).

Correspondingly, the current amplitude in the case of corrugated surface is I₀˜10⁻¹⁹ Ampere.

In addition to the above-mentioned noise of signal-registering electronics, other noise factors should be taken into amount. In particular, intrinsic thermodynamic noise (of Johnson-Nyquist origin) generated by electron-hole excitations is inevitable in superconductors. This noise contribution can be modeled via a finite resistor attached in parallel to the superconducting current lead. Then the average noise:

[symbol]

Iₙₒᵢₛₑ [symbol] =[4(k_{B}T/Rₙ]^{1/2}

where k_{B} is Boltzmann constant, T is the temperature in Kelvin, δv is the bandwidth, and Rₙ, is the resistance of the normal component of the superconductor.

Rₙ=(ρL/S)exp(Δ/(k_{B}T)

where ρ is the resistivity of normal electrons in a superconductor (not to be confused with the previous rho used for density), S is the wire cross-section, and Δ=Δ(T) is the BCS gap in the spectrum of unpaired excitation. For a single loop with d˜λ_{L} adopting ρ˜1 micro ohm cm, Δ˜10 MeV (superconductors with even larger gap values are readily available), and operational temperature T˜4K we have from (5): Rₙ˜10²⁰ Ohm. Substituting this into Eq. (4) and choosing, as above, dυ˜=1/t˜10⁻⁸ Hz yielding Iₙₒᵢₛₑ˜10⁻²⁵ Amperes. Though this is larger than the signal (the current I₀˜10⁻²⁵ Ampere in a single loop), for N loops the noise increases as N1/2, while the signal increases as N. Thus, at N>100 the signal becomes greater than thermodynamic noise, and the low limit of N (˜10⁵) is set by the noise floor of superconducting electronics considered above.

The case of corrugated wires can be analyzed in a similar manner. In this case the optimum cross-section is S˜ηdλ_{L}, so that the normal resistance of the corrugated path

[symbol]

Rₙₒᵢₛₑ^{corr} [symbol] ˜10¹³ Ohm

Accordingly, the average current noise of the corrugated path

[symbol]

Iₙₒᵢₛₑ^{corr} [symbol] ˜10⁻²¹ Ampere

which is orders of magnitude smaller than the value of signal current

[symbol]

I₀^{corr} [symbol] ˜10 −19 Ampere

As will be apparent to those skilled in the art, various changes and modifications may be made to the illustrated embodiment of the present invention without departing from the spirit and scope of the invention as determined in the appended claims and their legal equivalent.

1. A system for detecting and obtaining a signal representative of a gravitational wave, comprising:
a torque body having at least a bi-pole mass distribution and mounted for rotational movement about an axis in response to a gravitational wave;
a loop of superconducting material associated with the torque body for rotation therewith for generating a magnetic field in response to rotation of the torque body;
a magnetic field detector for detecting the magnetic field generated by the torque body in response to a gravitational wave; and
means for maintaining the temperature of the torque body and the loop of superconducting material below the superconducting transition temperature of the superconductor.

2. The system of claim 1, wherein the torque body is formed as a body of revolution about the axis and the torque body is fabricated from a superconducting material.

3. The system of claim 1, wherein the loop of superconducting material connected to the torque body comprises a closed loop of superconducting material attached to the torque body.

4. The system of claim 1, wherein the magnetic field detector comprises a SQUID detector.

5. A method for detecting and obtaining a signal representative of a gravitational wave, comprising the steps of:
providing a torque body having at least a bi-pole mass distribution and mounted for rotational movement about an axis in response to a gravitational wave;
providing a loop of superconducting material associated with the torque body for rotation therewith for generating a magnetic field in response to rotation of the torque body;
providing a magnetic field detector for detecting the magnetic field generated by the torque body in response to a gravitational wave; and
providing means for maintaining the temperature of the torque body and the loop of superconducting material below the superconducting transition temperature of the superconductor.
